(19) United States
(12) Patent Application Publication
(10) Pub. No.: US 2025/0103985 A1
(43) Pub. Date: Mar. 27, 2025

(54) ORCHESTRATED VISUAL GUIDANCE SYSTEM AND METHOD

(71) Applicant: ORACLE INTERNATIONAL CORPORATION, Redwood Shores, CA (US)

(72) Inventors: Venkateswarlu SREERAM, Venkatagiri (IN); Venkatesh Vinnod CHIKABELAPUR NAGARAJ, Cupertino, CA (US); Atanu MAJUMDAR, Palo Alto, CA (US); Atanu GUPTA, Fremont, CA (US); Krishna M. MULUKUTLA, Coppell, TX (US); Kartik RAGHAVAN, Pleasanton, CA (US)

(21) Appl. No.: 18/371,624

(22) Filed: Sep. 22, 2023

(51) Int. Cl. G06Q 10/0631; G06F 3/0482

(52) U.S. Cl. CPC G06Q 10/06316; G06F 3/0482

(57) ABSTRACT

Systems, methods, and other embodiments associated with a visual guidance model are described. In one embodiment, a method includes generating, via a graphical user interface (GUI), a multi-process scenario including creating one or more process goals, where each define a stage in a lifecycle of the multi-process scenario, and creating one or more objectives within each process goal that defines a task for accomplishing the corresponding process goal, and configuring at least one objective to display a description of the task performed by the objective. The example method may also include configuring, via the GUI, the objectives to include guided actions that partition the task to be performed into a sequence of guided actions for the corresponding objective, and for a selected objective, configuring, via the GUI, the guided action to display an explanation for how to perform the associated guided action upon being selected.

### BACKGROUND

Today many companies and businesses seek experienced professionals and consultants to provide routine professional development to ensure successful and productive employees accelerate company growth. Many of these experienced professionals and consultants have, over the course of decades of experience, developed various best practices, procedures, processes and other activities that are further developed and leveraged by businesses to become successful or to become leaders. Moreover, prior experience or training can be a very valuable asset to employers who wish to leverage employee experience to train other employees or obtain an edge in daily business activities. In an effort to retain these best practices, procedures, and processes, companies, many individuals, organizations, and businesses provide newly hired or untrained employees with a check list in place of training. While employees attempt to work efficiently and effectively, at least several problems exist with current practices, previous automated training systems, and models.

One problem that exists in automated training systems is that the system is static. They are based on a static check list that does not provide any guidance at any particular point in time or in real-time. While many daily activities, processes, and procedures are available to employees to help them be successful, many employees may be newly hired with little to no experience. Figuring out which procedure or process to follow can be daunting task for both employers and employees. Generally, employers may need to budget for training, workshops, and other tools and years of investment to get employees up to speed.

Another problem that exists is that employee day to day activities may still not be consistent among a group of employees or among employees at various departments, branches, and office locations. Further, it may be rare for individuals to successfully grasp and comprehend a year's worth of experiences in a limited amount of training or workshop time. Another problem that exists is that excessive training may give an unpleasant experience for employees that feel they are blindly following procedures they don't understand. Another problem that exists is that all too often these processes, procedures, activities, and practices remain only known to an experienced individual, and once these individuals leave the workforce their rich experience to handle complex business scenarios leaves with them.

### SUMMARY

In one embodiment, a computer-implemented method is described that includes using a graphical user interface (GUI) to generate a visual guidance model for a multi-process scenario. In one embodiment, a computer-readable medium is described that includes computer-executable instructions that when executed by at least a processor of a computer cause the computer to generate a visual guidance model for a multi-process scenario using a graphical user interface (GUI). In one embodiment, a computing system is described that includes a processor connected to a memory, and a computer readable medium that includes instructions that when executed by the processor cause the processor to generate a visual guidance model for a multi-process scenario. In these embodiments, a process is described that includes generating a multi-process scenario having one or more process goals, each process goal defining a stage in a lifecycle of the multi-process scenario. The process for creating the visual guidance model further includes using the GUI to create at least one objective within each process goal, each objective defining a task that is a part of accomplishing the corresponding process goal, and at least one objective displaying a description of the task performed by the objective. The process for creating the visual guidance model further includes using the GUI to configure at least one objective to include one or more guided actions that partition the task to be performed into a sequence of guided actions for the corresponding objective. The GUI further displays an explanation for how to perform the associated guided actions upon an objective being selected. A stage in the lifecycle of the multi-process scenario (i.e., a process goal) is completed when the sequence of guided actions within an objective is completed and when the objectives within the process goal are completed.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a computing system configured to provide a visual guidance model for orchestration of a guided experience and automation for a multi-process scenario.

FIG. 2 illustrates one embodiment of a method performed by the system of FIG. 1 for creating and configuring a visual guidance model for orchestration of a guided experience for a multi-process scenario.

FIG. 3 illustrates one embodiment of a run-time or operational method associated with user interaction with the system of FIG. 1 for interacting with a visual guidance model.

FIG. 4 is one embodiment of a schematic illustration of a process orchestration display screen in a graphical user interface (GUI) for creating an initial portion of a visual guidance model for a multi-process scenario associated with FIG. 1.

FIG. 5 is one embodiment of a schematic illustration of an objective display screen to create and define objectives for one orchestration or process in the multi-process scenario of FIG. 4 to be configured within the visual guidance model of the guidance system.

FIGS. 6A-6B illustrate one embodiment of a step diagram display screen of the GUI associated with the objectives screen from FIG. 5.

FIG. 7 illustrates one embodiment of editing a guided action/step from a diagram of an objective from FIG. 6A.

FIG. 8 illustrates one embodiment of a configuration of the guided action/step of FIG. 7 with properties and other related content.

FIG. 9 is one embodiment of a schematic illustration of a sequence of guided actions for another process goal (orchestration stage) from the multi-process scenario of FIG. 4.

FIG. 10 illustrates one embodiment of a user interface with a summary dashboard of progress for a guided action, an objective, and/or other portion of an orchestration.

FIG. 11 illustrates one embodiment of a user interface with automatic generation of an email template with populated information.

FIG. 12 illustrates an embodiment of a computing system configured with the example systems and/or methods disclosed.

### DETAILED DESCRIPTION

Systems and methods described herein as associated with a computer-implemented visual guidance system that is based on orchestrations, in one embodiment. The orchestrations serve to establish a visual guidance model that guides and directs individuals through best practices relevant to various situations in a dynamic process. By offering users a visually guided experience, the orchestrations facilitate the management of intricate and multi-step scenarios by providing descriptions of steps and also guidance on how to perform the steps. In one embodiment, the guidance system is configured to automatically perform a particular step/action.

In some examples, a situation can represent a process within a multi-step scenario. The present guidance system allows a scenario to be segmented into visual orchestration stages, and a stage in a given scenario can be further divided into substages, and so on. The visual orchestrations may be devised and configured in the guidance system to lead individuals through every stage, substage, and step of a multi-step process. The components of the multi-step scenario encompass informative, descriptive, and instructional content, all of which assist individuals in successfully executing each portion of the process. Additionally, the content associated with each facet of the multi-step scenario may include recommended practices aimed at training and aiding individuals in the successful completion of each corresponding part.

In one embodiment, the guidance system allows for a visual orchestration to be configured to include recommended steps and actions for a particular scenario or process and how to perform the steps/actions. For example, the visual orchestration may define a visual guidance model for designing a circuit board, building a computer, installing and troubleshooting an air conditioner, fixing a clogged drain, performing a sales lead qualification and closing deals in sales opportunities, or other desired process.

For example, a sales lead is a potential sales contact, who may be an individual or organization that expresses an interest in a company's goods or services. In order to acquire a potential sales contact, a multi-step process is undertaken to negotiate and discuss opportunities with the sales contact. Then a deal may be arranged and opportunity obtained by closing a deal. This process may be implemented in the guidance system as a visual guidance model based on best-practices of an organization.

In one embodiment, the visual guidance model that is created with the present guidance system provides a visual orchestration for learning and/or completing a process. The orchestration may be divided into orchestration stages, where each stage may be configured for a particular condition or status along the process.

Thus, for the sales leads example, different orchestration stages may be defined in the visual guidance model that outline the stage that the sales lead is in with the company, individual, organization, or business (e.g., a real-time status of the process). For example, a particular sales lead process may include different lead statuses such an “unqualified” lead, “qualified” lead, “converted” lead, and “retired” lead. Each status may be associated with a different set of recommended actions. The present guidance system allows an orchestration stage to be defined for each different status to provide guidance for performing actions in that particular situation. For explanatory purposes, which is not intended to be limiting, the following will be described with reference to a visual guidance model that is configured with an “unqualified” orchestration stage, “qualified” orchestration stage, “converted” orchestration stage, and “retired” orchestration stage. Each orchestration stage may be configured to describe a series of steps and/or actions (e.g., best-practice steps) that are recommended for an individual to handle situations, progress through steps, and complete the associated stage.

Previous guidance systems for completing tasks or managing an opportunity provided only a single set of linear recommendations with few or no options if a certain task or step failed or was delayed. Other previous guidance systems provided only a static check list of tasks and failed to provide specific recommendations that are configured to dynamically change based on current conditions of a scenario as in the present system.

With the present guidance system, orchestrations may be configured with dynamically changing flow using logic decisions that control multiple branches to suggest different actions when a particular step in a process does or does not succeed. For example, the user may be prompted to call a customer with the click of a button when a specific condition is detected. These and other features are described herein with reference to the attached figures.

### System Embodiment

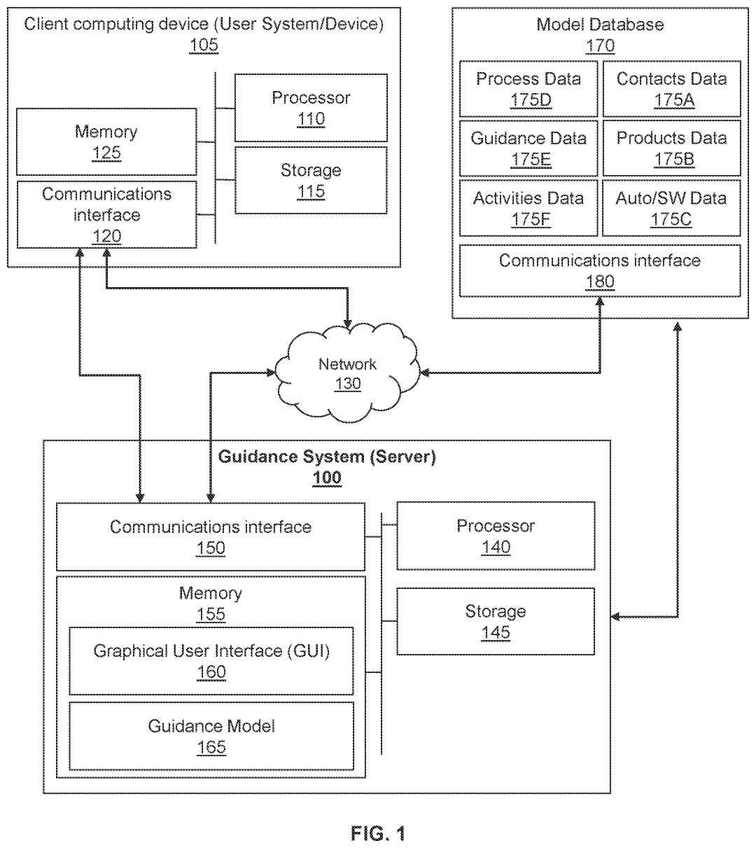

With reference to FIG. 1, one embodiment of a computing environment is illustrated that is configured with a guidance system 100. In one embodiment, the guidance system 100 is configured to provide a visual guidance model for orchestration of a guided experience of steps for a multi-process scenario. As shown in FIG. 1, the computing environment (e.g., a cloud-computing environment) provides network access to remote client devices such as client computing device 105. A client device may access and communicate with the guidance system 100 via a graphical user interface to create a visual guidance model (e.g., by an administrator) and/or access a visual guidance model for use as a guided orchestration (e.g., by a user being guided).

The client computing device 105 may include one or more processors 110, storage 115, communications interface 120, and computer-storage memory (memory) 125. The client computing device 105 may communicate directly with guidance system 100, as well as over a network 130. In one embodiment, an example guidance system 100 may be configured within a server for providing access to an orchestrated guided experience through a graphical user interface. The guidance system 100 may interact with one or more processors 140, storage 145, communications interface 150, computer-storage memory (memory) 155. The guidance system 100 may communicate over a network 130 with other devices, such as the client computing devices 105, model database 170, or other servers.

In some embodiments, the example network environment 130 may be a distributed client/server system that spans one or more networks. Network 130 may be a large computer network such as, for example, wide area network (WAN), the Internet, a cellular network, or a combination thereof connecting any number of mobile clients, fixed clients, and servers.

The storage 115 may include at least one of a semiconductor memory, a magnetic disk device, and/or an optical disk device, or the like, for example. The storage 115 may also store the application, simulation, software, automation and orchestration stages and stage elements, initialization data, background data, user account information, user data, etc., and the like. In addition, the storage 115 may also store temporary (e.g., preload or prefetch) data related to predetermined or anticipated automation and orchestration stages and stage elements, processing, sequences, instructions, tasks, and any combination thereof.

In one embedment, the communications interface 120 allows software, code, instructions, and data to be transferred between the client computer device 105 and external systems, databases, and devices over the network 130.

The memory 125 may store application, simulation, software, automation and orchestration stages, stage elements, initialization data, background data, user account information, user data, etc.

In one embodiment, the example guidance system 100 may be configured to be part of a networking environment for operating a cloud service in a cloud environment that provides content, media, files, and data for implementing a server-to-client communication system for providing the orchestrated guided experience through a graphical user interface.

As described herein, in one embodiment, the guidance system 100 is configured to provide a user interface and functions for creating a visual guidance model for a multi-process scenario. The visual guidance model may divide the multi-process scenario into a hierarchy of stages, actions, and/or steps for performing the multi-process scenario. The visual guidance model simplifies what may otherwise be a complex scenario into an easy-to-follow visual orchestration. The visual guidance model also configures a multi-process scenario into a consistent structure that may be followed and duplicated by many users from many different locations in a consistent manner. Without the visual guidance model, it may be very difficult for an inexperienced person to learn or perform the multi-process scenario and would be impossible for many users to consistently perform the multi-process scenario in the same manner.

In one embodiment, the hierarchy may be defined as or include orchestration stages, where a stage may present a user with a status, opportunity, or a lifecycle stage of a portion of the process. A different stage may be defined with guided actions/step for handling a different entity, product, business, service, scenario, a different real-time condition, etc. One or more components in the visual guidance model may be dependent upon another component (e.g., in a parent-child relationship). For example, a particular action/step may be dependent upon a first action/step being performed and completed successfully.

The visual guidance model may be configured to control the sequence of actions/steps in order to guide a user through the process correctly. The hierarchy created by the guidance system 100, guides users through the opportunity or process by providing them with an explanation and description of the stage and guidance to successfully complete the stage. In other words, the guidance system 100 creates stages, substages, and steps/tasks that guide users through a hierarchical process that divides a complex process or multi-process scenario into a sequence of steps and branch paths.

In one embodiment, the guidance system 100 may be configured in a computing environment that includes physical servers, virtual machines (VMs), or a combination thereof, and may include various dedicated, relational, virtual, private, public, hybrid, or other cloud-based resources. One skilled in the art will understand and appreciate that various server topologies may be used to construct the cloud environment. Moreover, guidance system 100 may communicate with model database 170 directly (when model database 170 is communicably coupled to storage 145) or through network 130.

The processor 140 may include any number of microprocessors, microcontrollers, graphics processing units (GPUs), central processing units (CPUs), quantum processing units (QPUs), analog circuitry, or the like that may be programmed to execute computer-executable instructions for implementing aspects of this disclosure. In some embodiments, the processor 140 may be programmed to execute instructions.

The storage 145 may include at least one of a semiconductor memory, a magnetic disk device, and/or an optical disk device, or the like, for example. The storage 145 may also store the application, simulation, software, automation and orchestration stages and stage elements, initialization data, background data, user account information, user data, etc., and the like. In addition, the storage 145 may also store temporary (e.g., preload or prefetch) data related to predetermined or anticipated automation and orchestration stages and stage elements, processing, sequences, instructions, tasks, and any combination thereof.

Furthermore, the storage 145 may access and store model data from model database 170, for example, contacts data 175A, products data 175B, automation/software data 175C, process data 175D, guidance data 175E, and activities data 175F. In addition, the storage 273 may also store temporary (e.g., preload or prefetch) data related to predetermined or anticipated processing, sequence, instruction, or task.

The communications interface 150 allows software, code, instructions, and data to be transferred between client computer devices 105, and/or one or more model databases 170, other guidance systems 100, and external devices over the network 130.

The memory 155 may store executable code of a graphical user interface (GUI) 160 and guidance model 165 to allow a user to display, configure, edit, and navigate through each process goal, objective, and guided action for a multi-process scenario implemented using an orchestrated guided experience with automation. The memory 155 may store application, simulation, software, automation and orchestration stages and stage elements, initialization data, background data, user account information, user data, etc., and the like, including media, user connection, preferences, configuration, and profiles, model data and model initialization information from a model database 170.

While the guidance system 100 is depicted as a single device, multiple guidance systems 100 may be used to work together and share the depicted server resources for implementing a server-to-client communication system for providing access to an orchestrated guided experience through a graphical user interface.

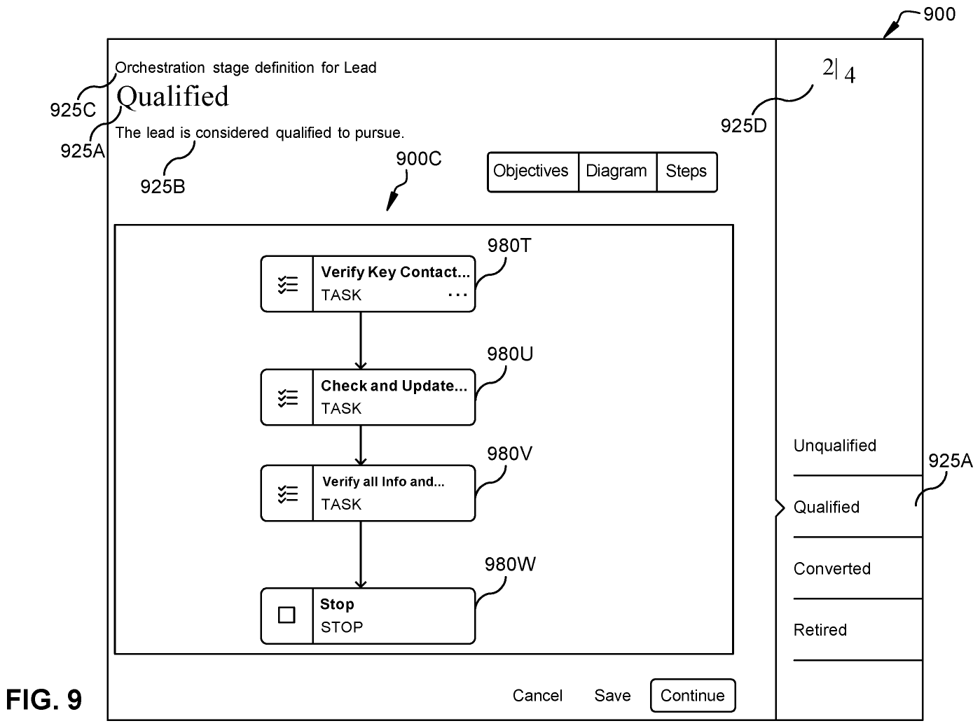

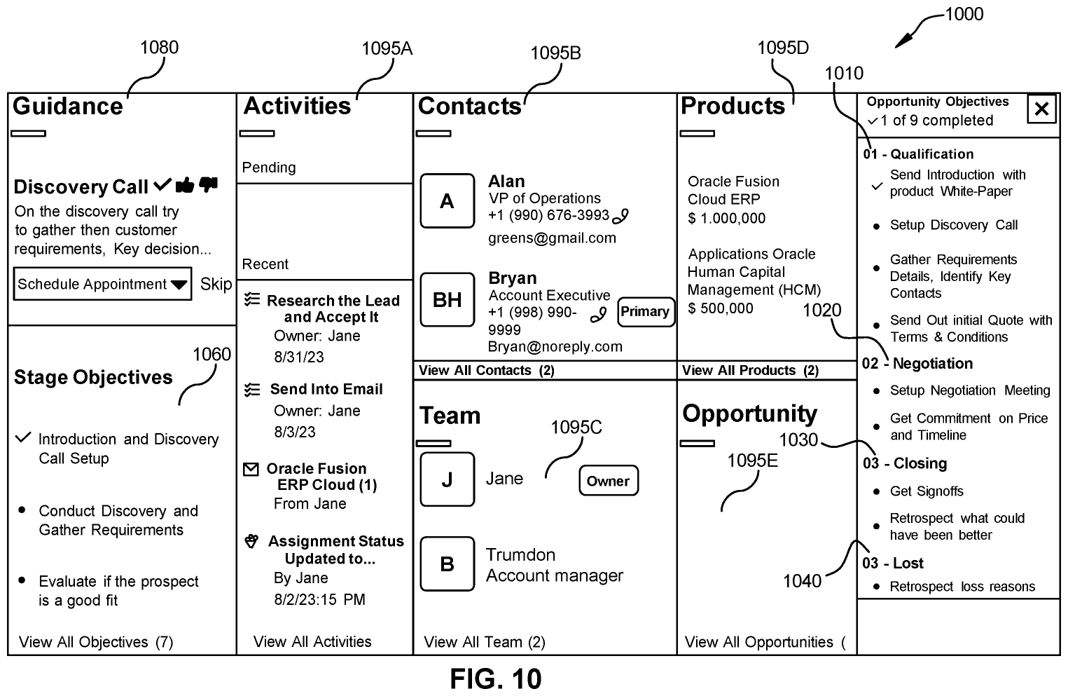

In one embodiment, the model database 170 may store guidance model data, for example, for populating guidance dashboards (e.g., dashboard 1000, dashboard 1100 of FIGS. 10-11 of a visual guidance model). Moreover, the model database 170 may include, for example, contacts data 175A, products data 175B, automation/software data 175C, process data 175D, guidance data 175E, and activities data 175F. In some embodiments, the model database 170 may include a communications interface 180 for providing model data to the client computing device 105, the guidance system 100, or a combination thereof. In some embodiments, the model database 170 may be a server, for example, a database server for storing and maintaining visual guidance models that have been created and may provide data for populating content for one or more guided actions, objectives, or process goals.

A visual guidance model created by the guidance system 100 helps professionals, individuals, or employees perform one or multiple processes in a multi-process scenario or a complex set of activities. Moreover, systems and methods described herein provide a visual guidance model that streamlines multi-process scenarios into a series of objectives and guided actions that taken together guide individuals throughout each process, objective, or guided action.

Many other previous guidance systems and methods were inconsistent, static, or ineffective. Unlike many other systems and methods, the visual guidance model disclosed herein is configured to dynamically analyze and identify different scenarios then guide users to successfully complete a process for a scenario using preferred, recommended, or ideal practices.

### Creating a Visual Guidance Model (Orchestration) Embodiment

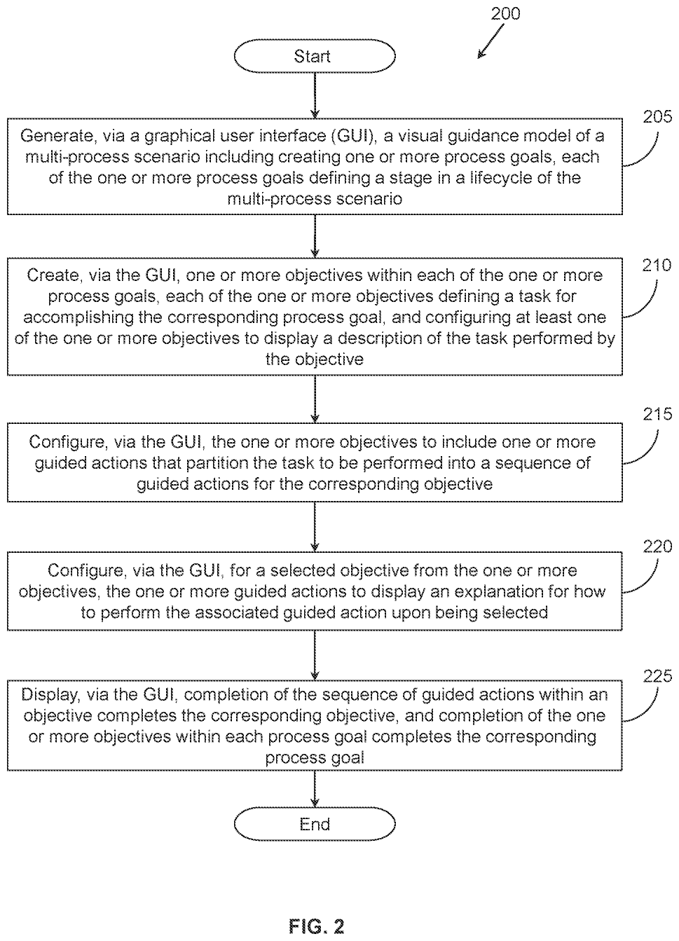

FIG. 2 illustrates one embodiment of a method performed by the guidance system 100 of FIG. 1 for creating a visual guidance model for orchestration of a guided experience for a multi-process scenario. Blocks shown in FIG. 2 may represent one or more processes, methods or subroutines, carried out in the exemplary method. FIG. 1 and FIGS. 4-13 show example embodiments of carrying out the method of FIG. 2 for creating, configuring, modifying and providing a visual guidance model for a multi-process scenario within a graphical user interface. Method 200 may be used independently or in combination with other methods or processes for creating a visual guidance model for orchestration of a guided experience and automation for a multi-process scenario. For explanatory purposes, the example process 200 is described herein with reference to FIG. 1 and FIGS. 4-13.

In one embodiment, method 200 may be implemented and performed by the guidance system 100 of FIG. 1. With the guidance system 100, a unique visual guidance model may be created for many different scenarios. The created guidance models may be stored in a database and made available for access by users. In operation, a user may access the guidance system 100, identify and select to use one or more of the available visual guidance models that are related to a process or scenario that the user is involved with. The selected guidance model may then be used to provide visual guidance for a particular process or scenario.

Method 200 begins at block 205, for example, when an administrator accesses the guidance system 100 to create a visual guidance model for a selected process/scenario or to modify an existing visual guidance model. In general, the following description uses the term “administrator” to refer to a person that is creating a visual guidance model and the term “user” to refer to a person that uses the visual guidance model to guide the user.

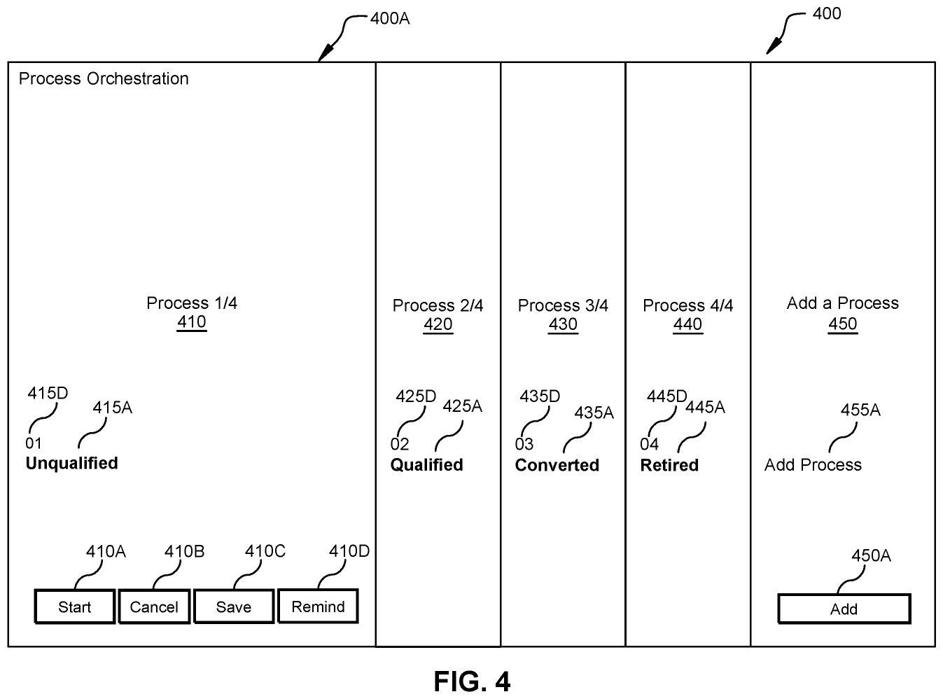

In block 205, the guidance system 100 displays a graphical user interface (GUI) configured for generating a visual guidance model of desired a multi-process scenario. In one embodiment, the visual guidance model is generated by creating one or more process goals, each process goal defining a stage in a lifecycle of the multi-process scenario. For example, the overall process orchestration (which is the visual guidance model) may be defined and broken into smaller orchestration stages. As one example, FIG. 4 illustrates a graphical user interface for adding one or more processes (stages) to an overall process orchestration. FIG. 4 is described in more detail below.

In one or more embodiments, the visual guidance model may define and display the multi-process scenario in a hierarchical structure of orchestration stages. However, depending on the multi-process scenario, the orchestration stages may be independent stages, which define different possible situations in the multi-process scenario. A stage of the multi-process scenario may be interactive (e.g., a modifiable object, menu, or text field). The guidance system GUI is configured to allow customization and configuration of the visual guidance model to add guidance, details, and an explanation to each part of the process goal, for example, the stage, substage, or step in each substage for the corresponding process goal.

The guidance system 100 may allow an administrator to define an orchestration for each process goal to guide, for example, employees through the multi-process scenario providing them with recommended practices to help employees successfully learn and complete a process. Further, the visual guidance model may divide the orchestration into orchestration stages, one for each status, stage, opportunity, or life cycle of an entity, product, business, service, scenario, etc. that may be part of the entire process being modeled.

For example, FIG. 4 shows one embodiment a process orchestration display screen 400A in a graphical user interface (GUI) 400 for creating an initial portion of a visual guidance model. FIG. 4 shows GUI options to add one or more sub-processes (e.g., “Add” button 450A) to an overall “Process Orchestration.” These sub-processes are also called “orchestration stages” herein since the stages together form the entire orchestration of the visual guidance model. FIG. 4 is described in more detail below.

With reference again to FIG. 2, at block 210, the GUI allows for the creation of at least one objective within each process goal. In one embodiment, defining any process is performed by using objectives instead of steps so that a variety of steps may be defined to accomplish the objectives, which in-turn would help achieve the end goal of the process. This abstracted definition of a process helps model any permutations/cases of scenarios and setup guidance steps to handle them.

For example, an objective may define a task that is part of accomplishing the corresponding process goal. At least one objective may be configured to display a description of the task associated with objective. An objective is not a step itself in the process, but more like a high-level task to be accomplished. In some embodiments, within each progress goal, or stage within the orchestration, the visual model may be configured with a plurality of objectives, and a description or explanation of the task accomplished by completing the objective. In the hierarchy, each objective includes one or more particular steps that are defined within the objective to accomplish the objective.

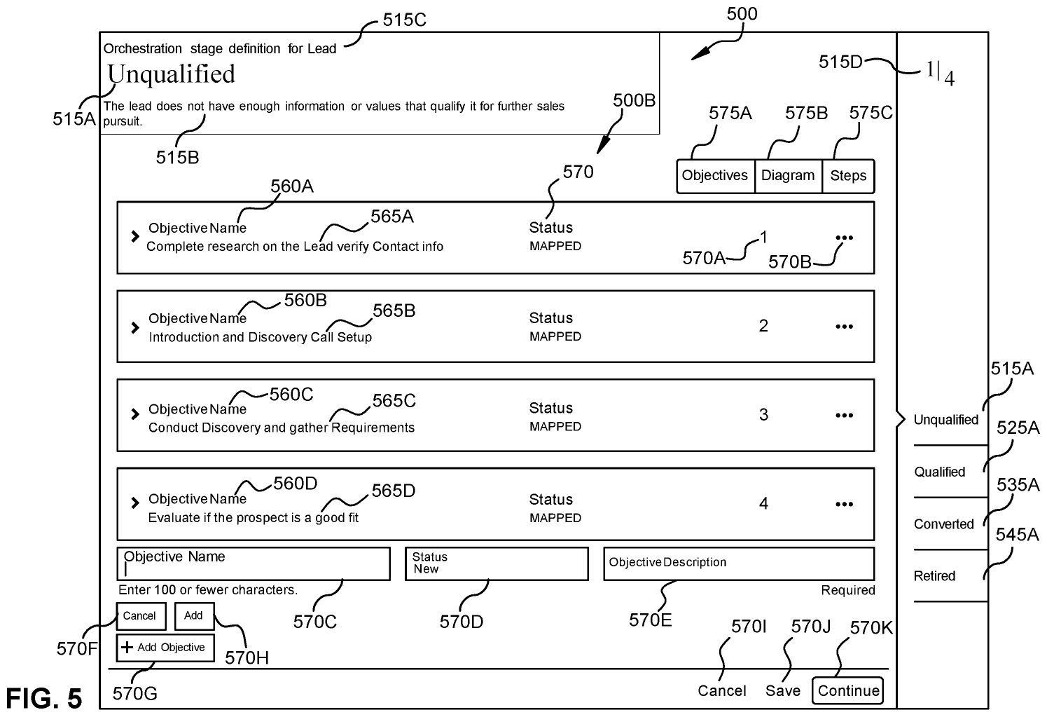

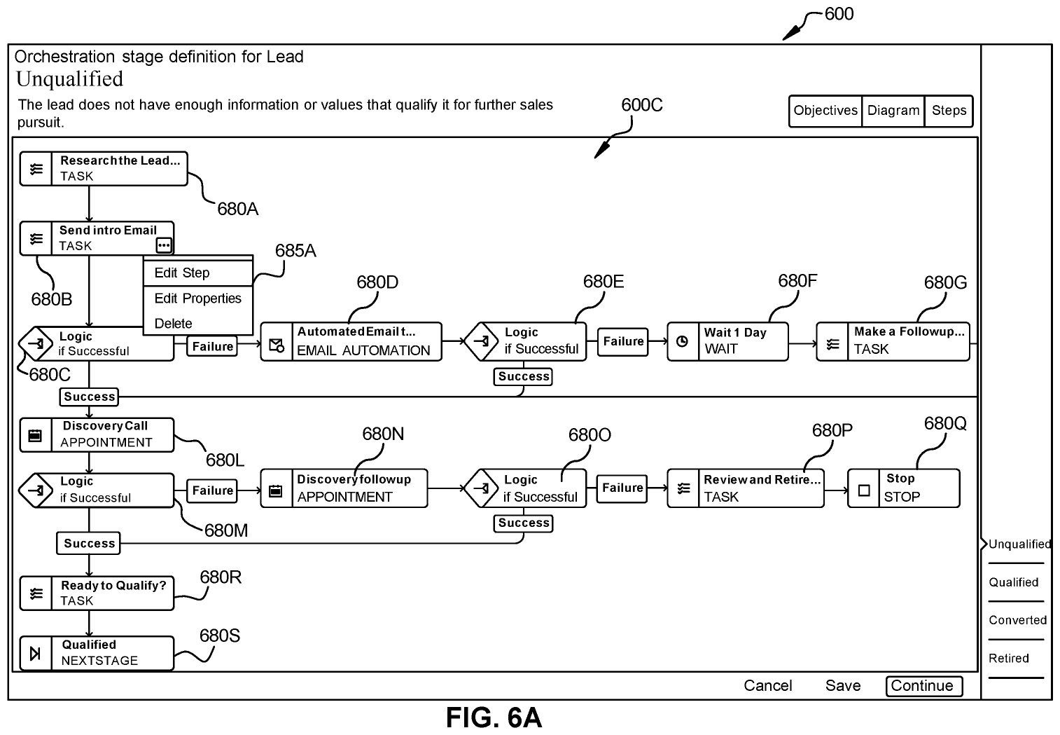

In one embodiment, the objectives may be created in sequence with an order and/or hierarchy for accomplishing the corresponding process goal in which the objectives are created. Each objective may include one or more steps (guided actions) that divide the task to be performed for the objective into a sequence of steps. Each step may further have a description and explanation to guide individuals to complete the task for the corresponding objective. One embodiment of an objectives definition page in the GUI is shown in FIG. 5 and one embodiment of a guided actions/steps page in the GUI is shown in FIGS. 6A-6B.

With reference to FIG. 5, one embodiment of an objectives definition page 500 is shown in the GUI for defining objectives for an orchestration stage. In the example, the visual guidance model being created is shown for an “Unqualified” orchestration stage 515A for a sales lead example previously discussed. The “Unqualified” orchestration stage is one of four orchestrations stages that have been created in this example guidance model. The other orchestration stages include “Qualified” 525A, “Converted” 535A, and “Retired” 545, which are shown and displayed in the lower right corner of the GUI screen in FIG. 5. The GUI may be configured to allow a user to select any one of the orchestration stages and in response, the GUI goes to that stage to define and display the guided actions/steps that are part of the selected stage. An example is shown in FIG. 6 described below.

With continued reference to FIG. 5, in another embodiment, the GUI may be used to generate a list of the one or more objectives for completing a corresponding process goal, wherein each described task for a corresponding objective describes a substage of the lifecycle for the corresponding process goal. An objective may be defined/described by a task that is to be completed. For example, the GUI allows objectives to be added to the orchestration stage by clicking an “Add Objective” button 570G. Input fields may be provided such as an objective name field 570C, objective status field 570D, and objective description field 570E. Four objectives are listed in FIG. 5 including objective names 560A-560D and corresponding objective descriptions 565A-565D. Each objective may include a status 570 to show the progress of the process goal.

Once the objectives for this stage are defined, the guidance model 100 then allows the administrator to create and define guided actions/steps that are recommended to be performed to complete each objective. This is described with reference to block 215 of FIG. 2 and FIG. 6A-6B. Moreover, each objective may form a tree or a diagram of steps, or otherwise a flow sequence of steps for visually guiding and informing a user on each objective/task of the process goal corresponding to the list of objectives.

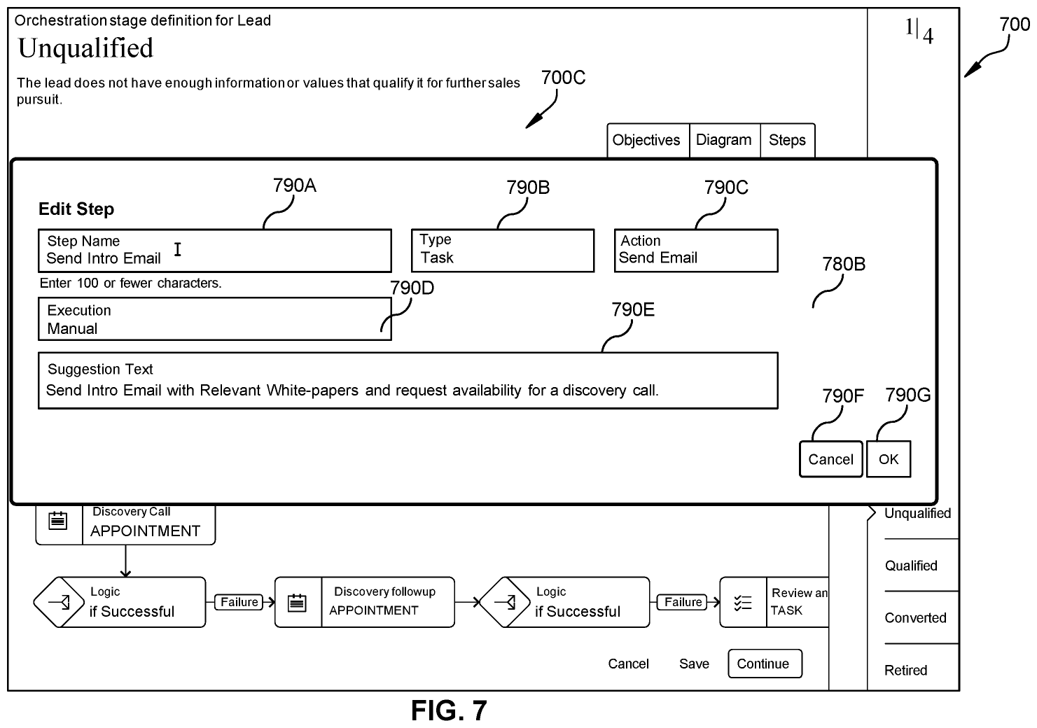

In one embodiment, a diagram function may be activated by toggling between views in the GUI with an Objectives view button 575A (view currently shown in FIG. 5) and a Diagram view button 575B (e.g., for defining and displaying a guided actions diagram for the corresponding stage, shown in FIGS. 6A-6B). The diagram function generates and displays the logical structure of the steps that have been created in the visual model for the orchestration (see FIG. 6A, for example). A Steps view button 575C may also be provided that is configured for defining and displaying individual steps of an objective (e.g., examples shown in FIG. 8).

With reference again to FIG. 2, at block 215, the GUI allows for configuring one or more objectives to include one or more guided actions/steps that partition the objective to be performed into a sequence of guided actions/steps for the corresponding objective. In one embodiment, the GUI (shown in FIG. 5) includes the Diagram button 575B and Steps button 575C that allow the objectives to be configured with particular guided actions. Clicking the Diagram button 575B takes the GUI to a steps diagram screen, for example, as shown in FIG. 6A.

In some embodiments, one or more objectives may be defined to display and describe a task. A task outlines and describes the intent in accomplishing the objective, and each objective may include one or more guided steps for completing the objective. In one embodiment, the guided actions divide the task into a sequence of steps. A guided action may be configured, using the GUI, to follow a sequence or flow to successfully accomplish a part of the task outlined for the objective. In one embodiment, the guided actions may be configured as a flow diagram, and each guided action may form one or more branches based on the result and action taken within the corresponding guided action.

In another embodiment, the GUI is configured to allow the administrator to generate a sequential diagram of one or more guided actions/steps within a corresponding objective. One example is shown in FIGS. 6A-6B. Although some portions of the diagram contain sequential steps in the flow, branch conditions may be defined to dynamically change the flow to other paths for performing other steps in response to a detected condition. When the diagram of guidance steps is followed by a user and the guidance steps are completed, the associated task described in the corresponding objective should be completed.

In one embodiment, the GUI provides options to add, edit, move, and delete actions/steps in the objective (e.g., see pop-up menu window 685A). Each action/step may be given a name and a description. An action/step may be configured as a manual step (step to be performed by a user) or an automatic step (step configured to be performed by the system). In one embodiment, the GUI may allow any action/step to be assigned a step type. A variety of step types may be defined that depend on the particular type of actions being performed and/or the type of process that is being guided. Step types may include, but are not limited to, Task, Appointment, Wait, Next Stage, Stop, Automation, Field Update, or other relevant types.

For example, the Task type may be for performing an action such as send email, initiate call, show contacts, create document X, etc. One or more actions may be configured with a smart action button that initiates and/or performs the corresponding action. In one embodiment, a task step may be defined with a completion due date. The guidance model may be configured to dynamically change the visual guidance to different “next steps” based on whether a user (who is being guided) completes the task by the due date or not. If the task is not completed by the due date specified, the orchestration moves to a next step that is designated “failure” next step. If the task is completed, then the orchestration moves to a “success” next step. Thus, the orchestration may be configured to dynamically changes its guidance based on real-time conditions or inputted conditions.

As another example, an Initiate Call step may be configured with a “Call” smart action may displays a “Call” button that the user (who is being guided) can click to open a soft phone. Any “smart” actions may be configured and assigned to a particular task to perform automatic actions such as, but not limited to, opening windows and displaying task information for the user to act on.

An “Appointment” step type may be configured to let the user (who is being guided) schedule an appointment with the click of a button. During setup of such a step, the administrator (who is defining the orchestration) may specify if the appointment will be a call or a web conference, for example. Suggestions for the step may also be defined such as suggesting appointment details, for example, timing, length, and participants. The appointments step may also be configured to allow the user to attach documents to be used in the appointment.

The “wait” step type may be used to create a step that pauses the orchestration for a number of days that are specified. The “next stage” step type may be used to move the guidance to the next orchestration stage. The guidance model may have more than one Next Stage step if the administration wishes the process to move to different stages depending on the outcome of a previous stage. The “Stop” step type may be used for indicating an end of a branch in the orchestration. The “Automation” step type may be configured to perform an automatic action that is configured using a script (e.g., a Groovy script) or other executable code. The “Field Update” step type may be configured to automate the updating of one or more data fields to specified/desired values.

With reference to FIG. 6A, one embodiment of a diagram page 600 is shown for the Unqualified orchestration stage. A diagram function generates and displays a logical structure of the actions/steps that have been created in the visual model for the orchestration stage. The diagram page 600 provides a flow sequence for the objectives previously defined. For example from FIG. 5, the objective “Introduction and Discovery Call Setup 565B is shown as “Discovery Call” step 680L in FIG. 6A. The diagram page 600 may be created and modified to include a plurality of guided actions/steps for performing the orchestration stage. The guided actions/steps may be positioned in a sequence diagram to provide a user with visual guidance on the action as well as the process.

FIG. 6A refers to the example “Unqualified” orchestration stage for a sales lead example previously discussed. The “Unqualified” orchestration stage is one of four orchestrations stages that exist in this example guidance model. The other orchestration stages include “Qualified,” “Converted,” and “Retired,” which are shown and displayed in the lower right corner of the GUI screen in FIG. 6A. The GUI may be configured to allow a user to select any one of the orchestration stages and in response, the GUI displays the guided actions/steps that are part of the selected stage.

The example “Unqualified” orchestration stage includes a number of tasks/actions (e.g., the blocks) in a flow diagram that may be created and defined using the guidance system 100 by the administrator. Once completed, the orchestration stage may be used to train, guide, or otherwise assist a user in performing this stage. Moreover, the sequence flow diagram may provide valuable information on a current action in the flow and future actions to be performed within the sequence of guided actions. In the above example, the guided actions provide individuals with guidance as well as direction and provide information when something goes wrong in a guided action.

As shown in FIG. 6A, for example, a user may be guided to make a “discovery call” step/action 608L, which has a step type of “Appointment.” A logic block 680M may be added to the flow and configured to control the flow based on whether the call was successful or not. If successful, the guided action takes the user to the next guided actions including “ready to quality” step 680R and then to “Qualified” step 680S. Step 680S takes the guidance model to the next orchestration stage called “Qualified.” If, at the call logic step 680M, the discovery call is unsuccessful, the flow moves to “discovery follow-up” step 680N where a different path guides the user to make follow up calls and may provide additional explanations for how to perform the follow up calls. If future contacts are also unsuccessful, the user is guided to a “review and retire” step 680P where the sales contact is retired and further attempts to reach the sales contact are stopped. These types of step sequences and flows may be created with the present guidance system 100 for any desired process.

Returning to FIG. 2, at block 220, using the GUI, for a selected objective, the corresponding one or more guided actions may be configured to display an explanation for how to perform the associated guided action upon being selected. In one embodiment, each guided action may be configured by the administrator to include content that explains the action performed for the guided action, for example, based on best practices or defined techniques. Further, each guided action may be configured to include content for performing the action manually or automatically.

For example, the guided action may be related to sending an email to a desired recipient (e.g., a sales contact). For such an action, the body and subject of the email may be prefilled with content such that the guided action provides information for individuals on the action performed, allows edits and customization for each guided action, and/or allows a user to manually perform the guided action (e.g., send the email) or automatically perform the guided action (e.g., send emails periodically until the sales contact responds). In one embodiment, within the visual guidance model, the GUI can be used by the administrator to add, edit, or customize each guided action (as well as each objective, and process goal) to include one or more text fields, radio buttons, action buttons (e.g., manual or automatic run/add/send/execute buttons), drop down fields, and the like.

In one embodiment, one or more steps may be configured to accept feedback from a user while performing the process. For example, the guidance model may allow a user to provide feedback or mark a step as “completed” or “not helpful” before the user may move to the next step in the guidance model. The administrator may then take the feedback and refine the guidance steps in the future. Although experienced users can skip the recommended steps or mark them as complete, orchestration is not to be viewed as a check list but rather guidance and recommended practices based on various factors involved in the multi-process scenario. The orchestration can suggest one or more remedial steps to be performed if results do not go as planned.

The systems and methods described herein may be used to analyze, via the visual guidance model, a result produced by completing at least one of the one or more guided actions for a particular objective to determine how to route to a following guided action in the sequence (e.g., route the model's progress to the next guided action assigned to the completed guided action). As shown in FIGS. 6A-6B, when using a visual guidance model, the user may choose to analyze a guided action in the guidance model, whether performed manually or automatically, as well as follow the sequence for a plurality of guided actions to determine whether to continue with the objective.

While working through the orchestration, a summary dashboard may be generated and displayed to assist the user with guidance and data relating to the current state of the progress made for an objective or a guided action. In one embodiment, a summary dashboard 1000 is shown in FIG. 10. This is described in more detail below.

In another embodiment, the GUI may be provide a feature to: (1) create one or more content operations that populate the explanation for the displayed guided action, where the displayed explanation guides a user on performing the guided action and preparing for the next guided action within the sequence of guided actions, and/or (2) create one or more autopilot operations that automatically populate content for automatically performing the guided action and complete one or more guided actions in the sequence of guided actions.

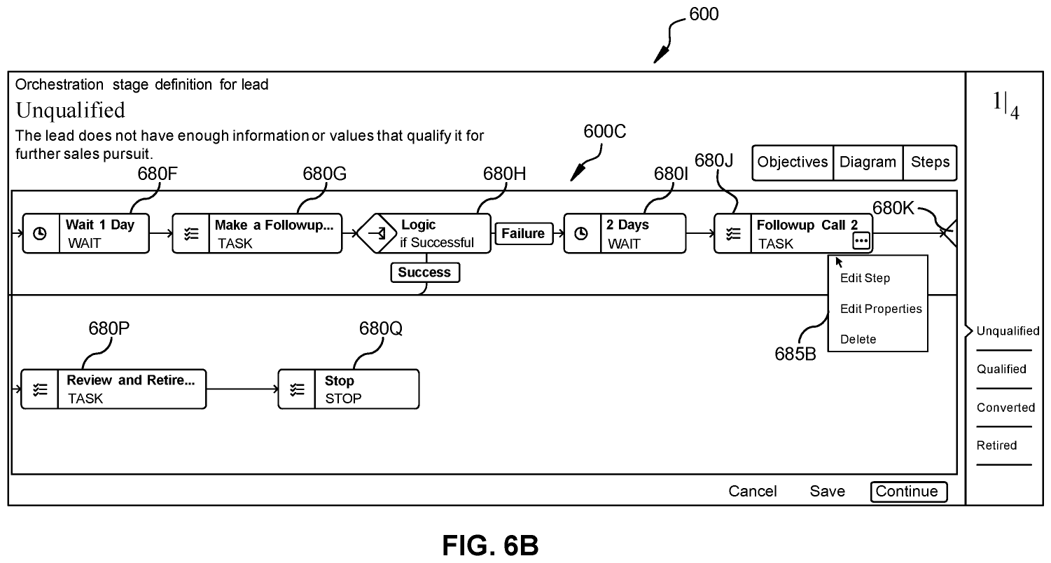

In one embodiment, a guided action may include one or more content windows (e.g., see FIGS. 7-8 within the visual guidance model or see FIGS. 10-11 within a network/online dashboard or user interface) that provide an explanation of the guided action (e.g., see FIG. 7). In some embodiments, each guided action may include an overview of the pre-filled content (or content retrieved from a template) and sequence of events (e.g., see FIG. 8). In some embodiments, each guided action may include pre-filled content that may be edited before being sent (e.g., see FIG. 11), or any combination thereof. Moreover, in some embodiments, each guided action may be configured to include one or more autopilot operations that automatically populate content for automatically performing the guided action and completing one or more guided actions in the sequence of guided actions. The content populated may be configured by the administrator based on defined functions for the guided action and/or current data and/or status that exists in the guided scenario. The user or employee may by provided with the option to select any guided action to run automatically and/or populate content and run automatically via button selections displayed by the visual guidance model.

In some embodiments, the content for one or more guided actions may be populated from one or more files or data from a model database 170. In certain embodiments, the content for one or more guided actions may be entered manually or retrieved by the system from one or more files or data within the model database 170. In certain embodiments, one or more guided actions may include executable code and be configured to automatically retrieve the content in part once the guided action is opened or instantiated. The populated or retrieved content for each guided action may provide an explanation, information, or guidance for the user to perform the guided action and prepare for the next guided action within the sequence of guided actions. A guided action may include an option to retrieve content from a template.

In another embodiment, using the visual guidance model, a content and a configuration of the one or more guided actions may be dynamically analyzed to identify one or more actions for automatically completing the corresponding guided action. For example, the visual guidance model may display the analyzed one or more guided actions as having a “pending” status. As shown in FIG. 10, the content of a guided action 1080 or a sequence of guided actions may generate and summarize data from what has happened during the orchestration, such as, activities 1095A that are pending and those that have already been perform during the orchestration (e.g., “Recent” activities).

The summary dashboard 1000 may also identify and display contacts 1095B associated with the company involved in the orchestration, and/or team members 1095C. For example, guidance on a discovery call 1080 may provide research activities (letters, documents, products, etc.,) to learn relevant data on the contacts, as well as guidance on contacting specific team members for assistance. In some embodiments, data on the opportunity (e.g., sales contact) may be analyzed by the guidance system 100, which may retrieve pertinent data from model database 170 (from FIG. 1) for completing one or more guided actions within the corresponding objective.

With reference again to FIG. 2, at block 225, the guidance system 100 allows the visual guidance model to be defined with a sequence of guided actions where completion of the sequence of guided actions within an objective completes the corresponding objective. This allows a user that is being guided by the visual guidance model to visually see when and how an objective is completed. Furthermore, completion of the one or more objectives that are defined in the visual guidance model within a process goal completes the corresponding process goal.

The steps of an orchestration stage may also describe how to get to another stage in the process. For example, the orchestration stage for an “unqualified” sales lead may describe and guide a user to different lead statuses (which guide the user to a different orchestration stage): to a qualified status, to a converted status, and to a retired status. Such statuses may be defined in the guidance model for the process as part of the orchestration and may include their own set of recommended steps to be performed when a situation is within that status. Thus, an orchestration defines and guides users through a multi-process scenario providing them with recommended practices to help individuals successfully complete a process.

In another embodiment, the GUI may provide progress indicators to display the status or completion of the sequence of guided actions within an objective. In some embodiments, the visual guidance model may be configured to set schedules, deadlines, timelines and other information, via the GUI, to provide users with progress feedback, schedules, and other information for time sensitive or timely responses to help the users become successful in completing a progress goal, an objective, or a guided action.

In another embodiment, at least one guided action may be configured, via the GUI, to include a user option that when selected automatically performs the guided action one or more times to obtain a result. The administrator may configure a guided action sequence that automatically performs a routine, iterative steps, or a frequent process with computer executed instructions/functions. For example, a guided action may be configured with an automated function for calling to schedule a meeting, sending email invitations to setup an interview, setting up an appointment, scheduling a product or service demonstration, etc.

The guided action may be configured with a selectable option (on the GUI) that allows a user to select a guided action sequence to run automatically. For example, preconfigured code may be executed to automatically and periodically call a sales contact to schedule a meeting (e.g., see FIG. 6B).

The guided action may be configured with logic to control the flow/sequence of the orchestrations. For example, if a call is successful, the guided actions help the user to set up an appointment to discuss opportunities. If the call is not successful (not able to contact the customer), the orchestration may be configured to wait for a day, and then prompt the user to make a follow-up call. Orchestration also improves on previous guided processes by supporting Smart Actions, an extensible framework for creating actions.

In another example, where in the process of scheduling a meeting, a guided action waits for a certain period (e.g., a day), then initiates a follow up call. This may be controlled by executable logic/code configured in the guided action. If the action is successful, the guided action may be configured to perform a second action such as directing the user to a discovery call appointment guided action, which may include all pertinent details for the call as shown in FIGS. 10-11.

If the automated guided action is not successful after a second follow up call, the process may be sent to a final step/process (e.g., a review and retire process) where the sales contact is deemed uninterested and the guided action sequence is terminated. Thus, the administrator may configure the orchestrated guided experience with automated actions to perform certain guided actions, for example, routine or time-consuming tasks, automatically and periodically. Further, the user or employee may enable a guided action sequence to run multiple times and automatically to obtain a result, which may allow the user to focus on other tasks, sales contacts or other opportunities.

Accordingly, with the present guidance system 100, orchestrations may be created that visually model various scenarios. The visual model is used to guide people through best practices for different situations. Although a sales scenario is described herein, the present system may be used to create a visual model for any scenario that includes multiple steps. The present system solves problems of previous static check-lists by providing a visual tool to dynamically model the experience, best-practices, tips and/or tricks that are known for a process as orchestrations guidance's. The allows the guidance system to dynamically analyze and identify different scenarios then guide a relatively inexperienced person to successfully complete the modeled scenario, such as a given work assignment.

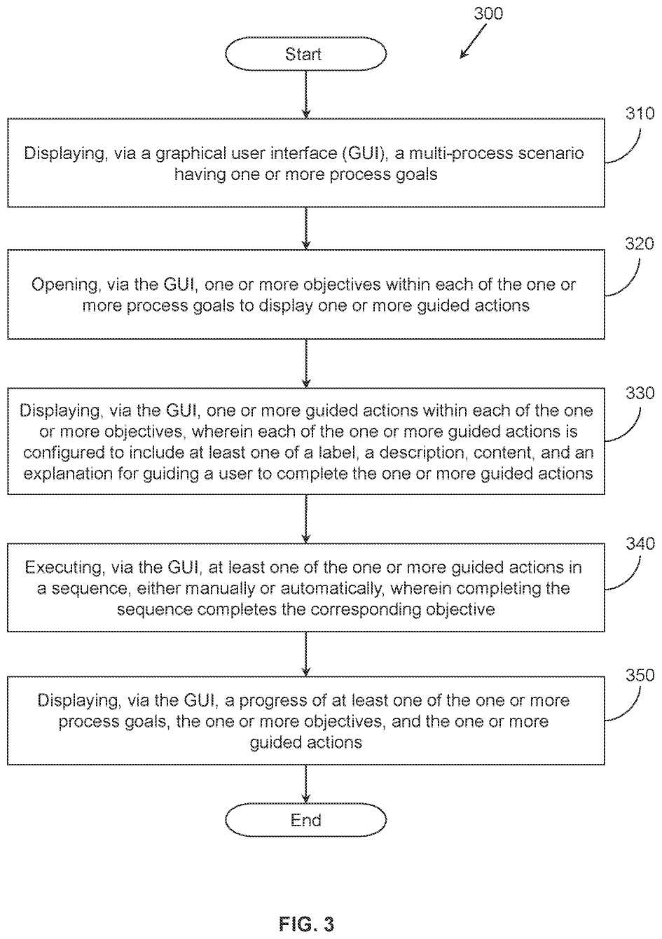

At runtime, a user can access a visual guidance model and easily work through a pre-modeled scenario leveraging the guided actions and recommendations provided. By using the visual guidance model, a user can be successful without the need to have any prior experience or training in the modeled scenario. This is further described with reference to FIG. 3.

### Run-Time Embodiment

FIG. 3 illustrates one embodiment of a method 300 that is associated with a run-time or operational user interaction with the guidance system 100 of FIG. 1. For example, method 300 may be performed in response to a user accessing the guidance system to interact with a visual guidance model that has been created and is available to guide the user through a scenario. These exemplary methods are provided by way of example, as there are a variety of ways to carry out these methods. Each block shown in FIG. 3 may represent one or more processes, methods or subroutines, carried out in the exemplary method. For explanatory purposes, method 300 will be described with reference to FIGS. 4-12, which show example embodiments for viewing, configuring, modifying and/or running a visual guidance model that provides an orchestration of a guided experience for a multi-process scenario.

Method 300 begins at block 310, for example, in response to a user accessing and selecting (via a GUI) a particular visual guidance model from a database. The guidance system may access and retrieve the selected visual guidance model from a database using network communications. In block 310, the selected visual guidance model is activated/executed and an initial page is displayed that shows a high-level of a multi-process scenario having one or more process goals (e.g., FIGS. 4-5 and 9). The user may access and view the multi-process scenario within the visual guidance model. In one embodiment, the multi-process scenario may include orchestration stages as described previously to help the user understand and complete each process goal within the multi-process scenario.

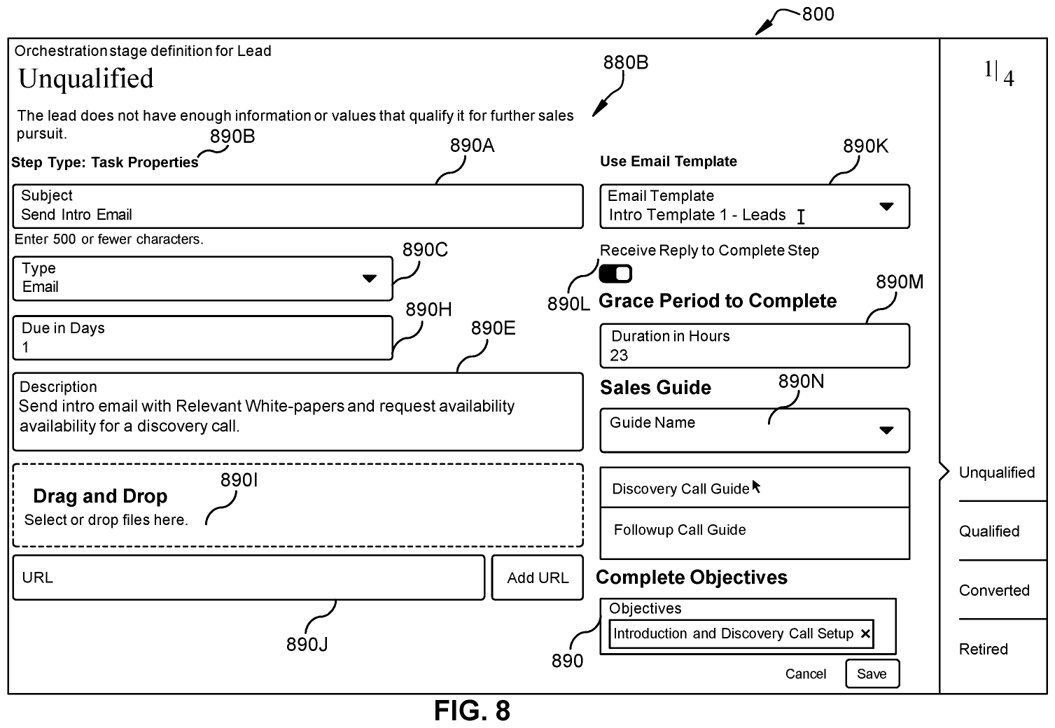

In block 320, the GUI may open and display one or more objectives within each of the one or more process goals (orchestration stages) and further display one or more guided actions/steps that are defined for the objectives. The user may access and view each objective within a process goal of the multi-process scenario (e.g., FIG. 5 objectives page within the visual guidance model). The visual model may then run through the objectives and display the guided actions/steps within the objective (e.g., FIGS. 6A-6B and 9 within the visual guidance model or FIG. 10 within the dashboard user interface 1000).

In block 330, the GUI of the guidance system may then display one or more guided actions within the one or more objectives, wherein the one or more guided actions is configured to include at least one of a label, a description, content, and an explanation for guiding the user to complete the one or more guided actions as defined by the visual model. The user may access and activate a guided action to display any associated content and/or recommendations (e.g., FIGS. 6A and 7-8 within the visual guidance model or FIGS. 10-11 within a network/online dashboard or user interface).

In one embodiment, the system may allow the user to reconfigure a guided action as desired as well as perform the guided action manually or automatically, if the guided action is configured with executable logic. For example, an edit menu 685A (FIG. 6A) may pop-up and provide options. The guided action/step may be for providing product or service information to a sales contact. The visual model may instruct the user to select a type of contact or communication, e.g., “Send intro email” step 680B select email, text message, etc. Content for the communication may then be automatically prefilled (since it was configured in the model) such that the guided action provides initial information for the user on the action performed. The user may then edit or customize the prefilled content for a guided action, and allows the individual to manually perform the guided action (e.g., send a text message) or automatically perform the guided action (e.g., system will send text messages periodically until a defined condition occurs).

In block 340, the visual model executes, via the GUI, at least one of the guided actions in a sequence. Whether the guided action is performed manually by the user or automatically by the system, the visual model shows how completing the sequence of actions completes the corresponding objective. The user of the visual guidance model may select each guided action to run automatically in the pre-configured sequence to obtain a result (e.g., FIG. 6A to FIG. 8)

In block 350, the visual model displays, via the GUI, a progress or status of at least one of the process goals (orchestration stages), the one or more objectives, and/or one or more guided actions based on the progress made by the user.

With reference to FIG. 10, a summary dashboard 1000 may be generated and displayed to assist the user with guidance and data relating to the current state of the progress made for an objective or a guided action. A sequence of guided actions may provide an overview of the progress and result of the guided action that may be used to determine whether to perform subsequent guided actions or move to subsequent objectives. For example, if the result of setting up a discovery call for a customer is successful and the customer wants to move to the next stage in a sales process, future guided actions in the guidance model are displayed and are visible to the user to move the user to the next stage.

As shown in FIG. 10, the individual may view a completed step within a selected objective to view their progress for completing a process goal. In one embodiment, an opportunity objective may include a list of steps (guided actions) that when completed, guide the individual towards completing other objectives for the corresponding process goal.

Accordingly, by using the present visual guidance model, an inexperienced user can learn and complete complex tasks that could not be performed by a static to-do list or checklist.

### Defining Orchestration Stages Embodiment

The functions of defining sub-processes (orchestration stages) for a visual model are discussed with reference to FIG. 2, block 205 and FIG. 4. With reference to FIG. 4, one embodiment of a schematic illustration of a process orchestration page 400A of a GUI 400 for creating and defining sub-processes (orchestration stages) for a process orchestration is shown. The GUI 400 may be implemented by the guidance system 100 associated with FIG. 1 and used as part of the method 200, block 205, in FIG. 2 described previously. As shown in FIG. 4, the process orchestration page 400A or home screen is displayed within a visual guidance model 400 being created. The visual guidance model allows an administrator to configure the process orchestration page 400A for any desired process.

The process orchestration page 400A allows the administrator to configure the overall process orchestration to include one or more sub-processes, also called orchestration stages. This allows the administrator to divide an overall orchestration, which may be complex, into smaller, more manageable sub-stages. The GUI may include a process Add button 450A that adds a new process (orchestration stage) to the model. In some embodiments, each process goal 410-440 may be further defined and configured to include one or more “objectives” as previously described. Each objective may further include a plurality of guided actions/steps are previously described.

In the example of FIG. 4, the overall Process Orchestration 400A is shown with four (4) sub-processes or orchestration stages. For example, Process 410 is an “Unqualified” orchestration stage, Process 420 is a “Qualified” orchestration stage, Process 430 is a “Converted” orchestration stage, and Process 440 is a “Retired” orchestration stage.

The visual guidance model 400 may include several action items for each process orchestration, for example, option to start 410A, cancel 410B, save a session 410C, and remind or schedule a follow up run 410D. In some embodiments, both the administrator and user may access the same visual guidance model 400 as shown in FIGS. 4-9. The administrator may configure how the user displays and interacts with the visual guidance model 400. In the user's case, the visual guidance model 400 may display, execute, run, or be customized or configured as needed or allowed by the administrator. In one embodiment, each process item or process goal 410, 420, 430, 440, 450 may include a descriptor or label 415A, 425A, 435A, 445A, 455A, and a process orchestration stage number 415D, 425D, 435D, 445D, respectively.

### Defining Objectives Embodiment

FIG. 5 is a schematic illustration of an objective definition page 500B for defining and configuring objectives for a selected orchestration stage shown in FIG. 3. As shown in FIG. 5, selecting the process goal start button 410A (from FIG. 4) displays the objective page 500B for process goal 410 (i.e., “Unqualified” orchestration stage 415A) of the process orchestration page 400A. In some embodiments, the visual guidance model 500 may display the process goals 515A, 525A, 535A, and 545A of process orchestration page 400A in sequence.

Moreover, other descriptors and labels for the objective page 500B corresponding to the process goal 410 may be shown, for example, process goal descriptor or label 515A and a process goal status or alerts 515B, and process goal identification tag 515C that identifies the page as “Orchestration stage definition for Lead.” The objectives 560A, 560B, 560C, and 560D and their corresponding description 565A, 565B, 565C, and 565D, respectively, are displayed. The objective status 570 and sequence 570A may also be provided to enable a user to view the objective. The objective page 500B may also include options for an administrator to configure each objective using settings configuration 570B, adding objectives 570G, using add/cancel 570H/570F buttons.

In one embodiment, the GUI provides input options for an objective to be given a name 570C, a status 570D, and a task description 570E. Further pages in the visual guidance model may include options to save 570J, cancel 570I, or continue 570K with a modification. The objectives page 500B may include options for toggling between objective view 575A (e.g., FIG. 5), guided actions diagram view 575B (e.g., FIGS. 6A-6B), and individual steps view 575C (e.g., FIG. 8).

In one embodiment, the “Steps” button 575C may be configured to add and define steps/guided actions for a selected objective. The steps may be created in a various sequences to create a guide flow of actions for performing the associated objective.

### Configuring and Displaying Guided Actions/Steps Embodiment

With reference to FIGS. 6A-6B, one embodiment of a diagram page 600 is shown for the Unqualified orchestration stage. A diagram function generates and displays a logical structure of the guided actions/steps that have been created in the visual model for the orchestration stage. Using this UI page, the administrator may add, edit, and delete steps in the sequence of guided actions.

The diagram page 600 may be displayed by selecting the Diagram button 575B (from FIG. 5) for an objective from the objective page of FIG. 5. The diagram displays a sequence of guided actions corresponding to the selected objective. As shown in FIGS. 6A-6B, selecting the guided actions diagram button 575B from objective page 500B for objective 560A shows a diagram of the guided actions sequence page 600C corresponding to objective 560A. Within the visual guidance model, a set of guided actions 680A-680S is ordered and displayed.

One or more sets of the plurality of guided actions 680A-680S may include step(s) for completing a corresponding objective 560A-560D. For example, objective name 560A is “Complete research on the lead, verify contact info” and labeled 565A, corresponds to the sequence of guided action 680A, objective 560B corresponds to the sequence of guided actions 680B-680K of FIGS. 6A-6B, objective 560C corresponds to the sequence of guided actions 680L-680O, and objective 560D corresponds to the sequence of guided actions 680P-680S of FIGS. 6A-6B.

In one embodiment, the guided actions 680A-680S may include a settings menu 685A, 685B, etc., allowing an administrator to configure the step (e.g., FIG. 7), edit properties of the step (e.g., FIG. 8), or delete the step. Moreover, each guided action may include a task connected with a series or sequence of logic blocks and automated actions. For example, guided actions 680A-680B, 680G, 680P, and 680R pertain to the tasks for the objectives 560A-560D, however to successfully complete a task corresponding to an objective, a user is guided through a sequence or series of guided actions (guided steps) created and outlined by an administrator. For example, guided action 680D pertains to an automated email that a user can run manually or opt to have run automatically through the visual guidance model 600.

Upon successful completion of guided action 680D at logic block 680E, the visual guidance model 600 routes a user to a guided action 680L for setting up an appointment for a discovery call. In addition to logic blocks 680C, 680E, 680H, 680K, 680M, and 680O, many other logic blocks may be configured to control a desired function or condition for other opportunities, scenarios, services, products, etc., and the like. Similarly, other steps may be included in the model, for example but not limited to, stop 680Q, wait/delay 680F, wait 680I, next process goal 680S, or other action blocks based on the recommended actions. As shown in FIG. 6B, a guided action 680J which is part of an automated guided action sequence may be selected for configuration by an administrator.

FIG. 7 illustrates one embodiment for editing a guided action/step from an objective of FIG. 6A. As shown in FIG. 7, the guided action 780B (680B of FIG. 6A) may be selected from within the guided actions sequence page 700C in the visual guidance model 700 for edit using settings menu 685A. In many embodiments, each guided action 680A-680S may have a unique or similar name 790A, type 790B, action 790C, execution 790D, and text description 790E, with cancel/confirm options 790F, 790G. The guided action 780B includes settings which determine the services or applications needed to automatically run the step or guided action 780B. For example, the experience individual may select the action as “send email” which may be preconfigured or configured to be associated with an email service or email application for automation. Moreover, the guided action 780 may be explicitly defined as automatic or manual execution 790D. Further, the guided action type 790B may be directly associated with the task 565B defined for the objective 560B.

FIG. 8 shows one embodiment of a configuration UI page 800 to configure a guided action/step from FIG. 7 with properties and other related content. As shown in FIG. 8, the guided action “Send Intro Email” 880B corresponds to “Send Intro Email” step 680B of FIG. 6A. The configuration UI page 800 may be displayed in response to the edit settings pop-up menu 685A being selected (see FIG. 6A) to edit the “Send Intro Email” step 680B. Selecting the edit preferences from the settings menu 685A, displays preferences of guided action 880B via the configuration UI page 800 for the visual guidance model.

In one embodiment, the guided action/step may include a variety of input fields for configuring the associated guided action/step. The input field may include, but are not limited to, a subject 890A, guided action type 890B, action/service/program type 890C, deadline 890H, text description 890E, attachment options 890I, Universal Resource Locator (URL) attachment 890J, an email template 890K for prefilling an email with content, execution option(s) 890L, grace period for completion 890M, name/type of guidance 890N, and objective association 890O. The guided action 880B may automatically generate or associate with one or more relevant services, programs, or applications needed to automatically run the step or guided action 880B. The administrator may define how each guided action 880B is associated with the objective 560B, for example, by defining the guided action type 890B, action/service/program type 890C which determine in the guided actions sequence page 600C whether the guided action is a logic block, a task defined by the objective, or otherwise.

Further, the guided action 880B may be defined to include deadlines 890H for completion, a grace period 890M, a template 890K for guiding a user and completing the guided action 880B, and a template or guide name 890N that allows a user to follow an established guide for the task or guided action 880B. Further, the guided action 880B may direct a user to a subsequent or following guided action or objective upon completion by defining how to route to the next guided action or objective using the objective association 890O.

FIG. 9 illustrates one embodiment of a diagram view of a sequence of guided actions for process goal 420 from FIG. 4, namely, the “Qualified” orchestration stage. The guided actions may be configured within the visual guidance model of the guidance system and viewed or executed by a user on a user interface. In one embodiment, selecting the “Diagram” view button for the “Qualified” orchestration stage displays one or more guided actions/steps 980T, 980U, 980V, and 980W that have been defined and may be configured. This is similar to the diagram view and associated configuration features for the “Unqualified” orchestration stage shown in FIG. 6A.

FIG. 10 illustrates one embodiment of a user interface and summary dashboard 1000, as previously described, relating to the current state of the progress made for an objective or a guided action. The dashboard 1000 may list the available guided actions, objectives, activities, contacts, and other information for completing an objective and/or process. The summary user dashboard 1000 may be provided as a network/online user interface for accessing one or more process goals 1010, 1020, 1030, 1040, one or more objectives 1060, and one or more guided actions 1080.

In one embodiment, the user dashboard 1000 may include activities 1095 populated by the guidance system 100 and/or content from the model database 170 that includes relevant information based on the current guided action of the visual guidance model (e.g., the Discovery Call action). Moreover, the user dashboard 1000 may populate relevant activities 1095A, contact details 1095B, team members 1095C, products 1095D, or opportunities 1095E, or any combination thereof based on the process goal, objective, customer, client, service, or other opportunity, or multi-process scenario.

### Automated Guided Actions Embodiment

FIG. 11 illustrates one embodiment of an automated guided action/step that can generate a user interface dashboard 1100 with a template document and pre-fill or populate the template with content. In this example, an email template is generated and populated with content based on the configuration of the visual guidance model. The user may then make edits to the content and perform the action (e.g., send the email). In one embodiment, the guided action/step for performing this function may be configured with logic or other executable code for obtaining a selected template document and populating the fields of the document with data from relevant data records associated with the orchestration.

As shown in FIG. 11, the user interface 1100 may allow a user to select and configure the components of the generated email template such as header 1180A and other content. In some embodiments, a user, upon opening the guided action 1180A and specifying a recipient, may obtain an autogenerated email body 1190K, prep-populated based on the recipient 1190M, activity 1095A (FIG. 10), product records 1095D (FIG. 10), the subject 1190A, and contact details 1195B that are retrieved and populated from the contacts records 1095B (FIG. 10). Moreover, dashboard 1100 may provide a user with notification of pending 1190P guided actions.

Referring to FIGS. 10-11, in some embodiments, each orchestration step that requires a user to take an action, may appear as a recommendation at the top of the activities 1095A panel and page. As shown in FIG. 7, users may see both the step name 790A and the description that the administrator enters in the suggestion text field 790E. Only manual steps appear as recommendations in the user dashboard 1000. Manual steps ask the user to take an action, automatic steps take automatic steps in the background without input from the user. For steps that don't use smart actions, e.g., manual tasks, as shown in one or more guided actions 1080, the user can either click complete (check mark), helpful (thumbs up), or not helpful (thumbs down). Selecting options may move the orchestration to the next step. Clicking complete closes the task and also marks any objective linked to the step as complete.

Smart actions may be configured to display a button with the name of the action. Clicking the action button initiates the action and moves to the next step. Smart actions can take automatic actions, such as opening windows and displaying information for users to act on. The opportunity 1095E objectives summary tells the user how many of the objectives for the opportunity have been met. Clicking the link displays the panel showing the objectives. The listing shows which objectives have been met with a check mark. The list of objectives for the opportunity that the user can display by clicking the link for view all objectives. Objectives that users skip may be marked by an X. Users can return to mark an objective as complete at any time by clicking a link. In some embodiments, when users return to a skipped objective, they can mark it as complete, however they would not be able to carry out the smart action.

The orchestration functionality described herein provides many notable features, for example, design time experience where an administrator can visually model various scenarios using an intuitive orchestration designer functionality. Another feature is objective definition, where the concept of defining any process is performed by using objectives instead of steps so that variety of steps may be defined to accomplish the objectives which in-turn would help achieve the end goal of the process. This abstracted definition of a process helps model any permutations/cases of scenarios and setup guidance steps to handle them.

Another feature may include functional architecture, for example, the orchestration is functionally modeled and architected in such a way, that activities (tasks and appointments) are the backbone to support providing guidance's to the users from the workforce. In one embodiment, a modeled orchestration may facilitate use of external calendaring apps to view guidance that may be integrated within a central exchange server, for example. An appointment guidance may automatically show in a phone calendar for a sales rep to view and work on or some other 3rd party calendaring app the workforce may be using with a server.

Unlike existing solutions for process management, the present orchestration system does not provide a flat checklist of to-dos for a user to go through, agnostic of the specific scenario; it may provide one relevant guidance with a recommended action button that could be used to take that recommended action. Moreover, unlike existing methods, the present orchestration system is a generic framework that may be used in any process.

In another embodiment, the present orchestration system may be configured to use inputs from internal or third party AI engines for conditional branching making it extremely powerful since it can leverage AI to accurately identify specific scenarios and guide users. The present orchestration system provides an improved runtime experience, where a new user experience through orchestration guidance allows users/workforce to conveniently take recommended actions from multiple places in the guidance system. Further, the orchestration system may be easily integrated with existing applications, software, and programs making it easy to handle a large variety of bulk operation use cases.

The present orchestration/guidance system provides several functional advantages. One advantage, in the case of a sales lead, the user can provide sales reps with a “guided selling experience” where the sales application can become a partner to the sales rep, guiding and assisting the sales rep in using the best strategies to close a sale based in the unique sales scenario. Another advantage, is that orchestrated guided experience may boost productivity of a workforce as orchestration attempts to minimize idle time and time spent on: strategizing next steps, for example, “trying to figure out what to do next”, discovery, for example, “what relevant content to communicate with based on a situation,” execution, for example, “trying to figure out how to do the action,” and data entry, “manually documenting, entering data completing tasks etc.”

Moreover, the present orchestration/guidance system may also reduce the need for training a workforce in processes and relying on individual's experiences to accomplish objectives and goals. Further, the orchestrated guided experience with automation would help reduce the close times for opportunities and lead qualifications, resulting on cost saving and higher revenue due to higher deal closures.

### Definitions

A “content”, “explanation”, “status”, “template”, or “description” as used herein includes, but is not limited to, text that may provide a description, guidance, information, or recommendation for one or more tasks, objectives, guided actions, or one or more process descriptions.

### Computing Device Embodiment

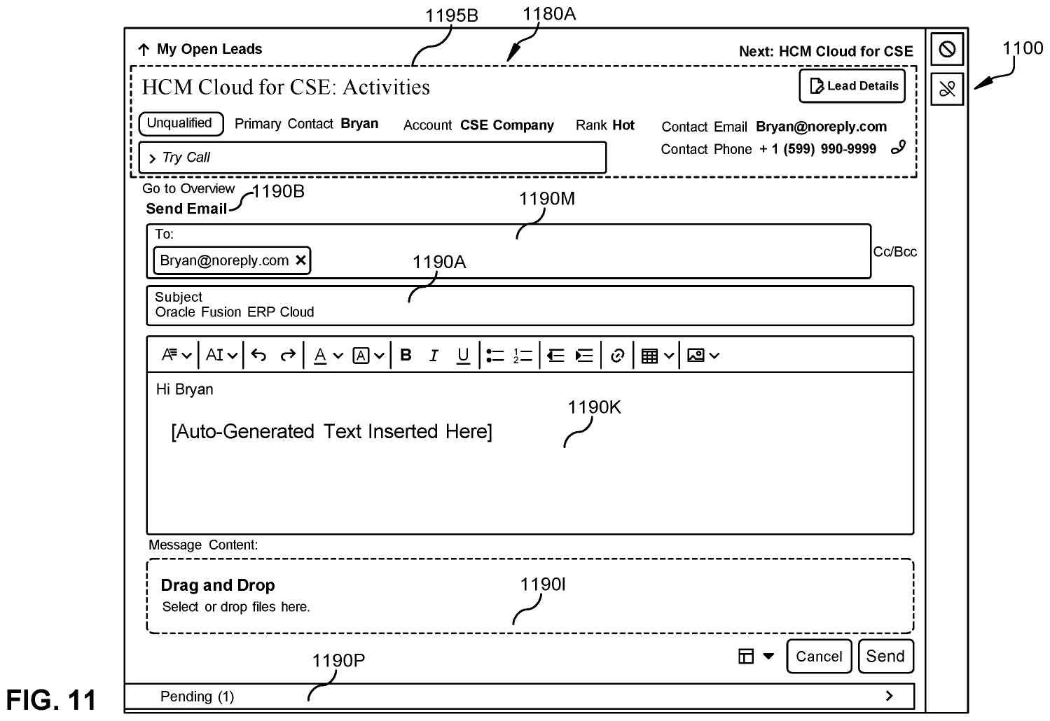

FIG. 12 illustrates an example computing device that is configured and/or programmed as a special purpose computing device with one or more of the example systems and methods described herein, and/or equivalents. The example computing device may be a computer 1200 that includes at least one hardware processor 1202, a memory 1204, and input/output ports 1210 operably connected by a bus 1208. In one example, the computer 1200 may include guidance logic 1230 configured to facilitate an orchestrated guided experience as the guidance system 100 and associated figures. The guidance logic 1230 creates a hierarchy of a multi-process scenario, the hierarchy is further defined as orchestration stages, each stage may present a user with a status, opportunity, or a lifecycle stage of an entity, product, business, service, scenario, etc. The hierarchy created by the guidance logic 1230, guides users through the opportunity or process providing them with an explanation and description of the stage and guidance and automation to successfully complete the stage. In other words, the guidance logic 1230 creates stages, substages, and steps/tasks that guides users through hierarchal process that divides a complex process or multi-process scenario into a sequence or diagram of steps, tasks, substages, and stages.

In different examples, the logic 1230 may be implemented in hardware, a non-transitory computer-readable medium 1237 with stored instructions, firmware, and/or combinations thereof. While the logic 1230 is illustrated as a hardware component attached to the bus 1208, it is to be appreciated that in other embodiments, the logic 1230 could be implemented in the processor 1202, stored in memory 1204, or stored in disk 1206.

In one embodiment, logic 1230 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate an orchestrated guided experience with automation through a graphical user interface creating a hierarchy of a multi-process scenario, the hierarchy is further defined as orchestration stages, each stage may present a user with a status, opportunity, or a lifecycle stage of an entity, product, business, service, scenario, etc. The means may also be implemented as stored computer executable instructions that are presented to computer 1200 as data 1216 that are temporarily stored in memory 1204 and then executed by processor 1202.

Logic 1230 may also provide means (e.g., hardware, non-transitory computer-readable medium that stores executable instructions, firmware) for performing one or more of the disclosed functions and/or combinations of the functions.

Generally describing an example configuration of the computer 1200, the processor 1202 may be a variety of various processors including dual microprocessor and other multi-processor architectures. A memory 1204 may include volatile memory and/or non-volatile memory. Non-volatile memory may include, for example, ROM, PROM, and so on. Volatile memory may include, for example, RAM, SRAM, DRAM, and so on.

A storage disk 1206 may be operably connected to the computer 1200 via, for example, an input/output (I/O) interface (e.g., card, device) 1218 and an input/output port 1210 that are controlled by at least an input/output (I/O) controller 1240. The disk 1206 may be, for example, a magnetic disk drive, a solid state disk drive, a floppy disk drive, a tape drive, a Zip drive, a flash memory card, a memory stick, and so on. Furthermore, the disk 1206 may be a CD-ROM drive, a CD-R drive, a CD-RW drive, a DVD ROM, and so on. The memory 1204 can store a process 1214 and/or a data 1216, for example. The disk 1206 and/or the memory 1204 can store an operating system that controls and allocates resources of the computer 1200.

The computer 1200 may interact with, control, and/or be controlled by input/output (I/O) devices via the input/output (I/O) controller 1240, the I/O interfaces 1218, and the input/output ports 1210. Input/output devices may include, for example, one or more displays 1270, printers 1272 (such as inkjet, laser, or 3D printers), audio output devices 1274 (such as speakers or headphones), text input devices 1280 (such as keyboards), cursor control devices 1282 for pointing and selection inputs (such as mice, trackballs, touch screens, joysticks, pointing sticks, electronic styluses, electronic pen tablets), audio input devices 1284 (such as microphones or external audio players), video input devices 1286 (such as video and still cameras, or external video players), image scanners 1288, video cards (not shown), disks 1206, network devices 1220, and so on. The input/output ports 1210 may include, for example, serial ports, parallel ports, and USB ports.

The computer 1200 can operate in a network environment and thus may be connected to the network devices 1220 via the I/O interfaces 1218, and/or the I/O ports 1210. Through the network devices 1220, the computer 1200 may interact with a network 1260. Through the network, the computer 1200 may be logically connected to remote computers 1265. Networks with which the computer 1200 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, the method comprising:
generating, via a graphical user interface (GUI), a visual guidance model of a multi-process scenario including creating one or more process goals, each of the one or more process goals defining a stage in a lifecycle of the multi-process scenario;
creating, via the GUI, one or more objectives within each of the one or more process goals, each of the one or more objectives defining a task for accomplishing the corresponding process goal, and configuring at least one of the one or more objectives to display a description of the task performed by the objective;
configuring, via the GUI, the one or more objectives to include one or more guided actions that partition the task to be performed into a sequence of guided actions for the corresponding objective;
for a selected objective from the one or more objectives, configuring, via the GUI, the one or more guided actions to display an explanation for how to perform the associated guided action upon being selected; and
wherein completion of the sequence of guided actions within an objective completes the corresponding objective, and completion of the one or more objectives within each process goal completes the corresponding process goal.

2. The computer-implemented method of claim 1, further comprising, generating, via the GUI, a list of the one or more objectives for completing a corresponding process goal, wherein each described task for a corresponding objective describes a substage of the lifecycle for the corresponding process goal.

3. The computer-implemented method of claim 1, further comprising, generating, via the GUI, a sequential diagram of the one or more guided actions within a corresponding objective, wherein the sequence diagram, completed in whole, performs the task described in the corresponding objective.

4. The computer-implemented method of claim 1, further comprising, analyzing, via the visual guidance model, a result produced by completing a first guided action from a first objective to determine how to route to a following guided action in the sequence.

5. The computer-implemented method of claim 1, further comprising, creating, via the GUI, at least one of:
one or more content operations that populate the explanation for the displayed guided action, the displayed explanation guiding a user on performing the guided action and preparing for the next guided action within the sequence of guided actions, and
one or more autopilot operations that automatically populate content for automatically performing the guided action and complete one or more guided actions in the sequence of guided actions.

6. The computer-implemented method of claim 5, further comprising, dynamically analyzing, via the visual guidance model, a content and a configuration of the one or more guided actions to identify one or more actions for automatically completing the corresponding guided action, and wherein the visual guidance model displays the analyzed one or more guided actions as pending.

7. The computer-implemented method of claim 1, further comprising, configuring, via the GUI, at least one guided action of the one or more guided actions to include a user option that when selected automatically performs the guided action multiple times to obtain a result.

8. A non-transitory computer-readable medium that includes stored thereon computer-executable instructions that when executed by at least a processor of a computer cause the computer to:
generate, via a graphical user interface (GUI), a visual guidance model of a multi-process scenario including creating one or more process goals, each of the one or more process goals defining a stage in a lifecycle of the multi-process scenario;
create, via the GUI, one or more objectives within each of the one or more process goals, each of the one or more objectives defining a task for accomplishing the corresponding process goal, and configuring at least one of the one or more objectives to display a description of the task performed by the objective;
configure, via the GUI, the one or more objectives to include one or more guided actions that partition the task to be performed into a sequence of guided actions for the corresponding objective;
for a selected objective from the one or more objectives, configuring, via the GUI, the one or more guided actions to display an explanation for how to perform the associated guided action upon being selected; and
wherein completion of the sequence of guided actions within an objective completes the corresponding objective, and completion of the one or more objectives within each process goal completes the corresponding process goal.

9. The non-transitory computer-readable medium of claim 8, further comprising instructions that when executed by at least the processor cause the processor to:
generate, via the GUI, a list of the one or more objectives for completing a corresponding process goal, wherein each described task for a corresponding objective describes a substage of the lifecycle for the corresponding process goal.

10. The non-transitory computer-readable medium of claim 8, further comprising instructions that when executed by at least the processor cause the processor to:
generate, via the GUI, a sequential diagram of the one or more guided actions within a corresponding objective, wherein the sequence diagram, completed in whole, performs the task described in the corresponding objective.

11. The non-transitory computer-readable medium of claim 8, further comprising instructions that when executed by at least the processor cause the processor to:
analyze, via the visual guidance model, a result produced by completing at least one of the one or more guided actions to determine how to route to a following guided action in the sequence.

12. The non-transitory computer-readable medium of claim 8, further comprising instructions that when executed by at least the processor cause the processor to: create, via the GUI, at least one of:
one or more content operations that populate the explanation for the displayed guided action, the displayed explanation guiding a user on performing the guided action and preparing for the next guided action within the sequence of guided actions, and
one or more autopilot operations that automatically populate content for automatically performing the guided action and complete one or more guided actions in the sequence of guided actions.

13. The non-transitory computer-readable medium of claim 12, further comprising instructions that when executed by at least the processor cause the processor to:
dynamically analyze, via the visual guidance model, a content and a configuration of the one or more guided actions to identify one or more actions for automatically completing the corresponding guided action, and wherein the visual guidance model displays the analyzed one or more guided actions as pending.

14. The non-transitory computer-readable medium of claim 8, further comprising instructions that when executed by at least the processor cause the processor to:
configure, via the GUI, at least one guided action of the one or more guided actions to include a user option that when selected automatically performs the guided action multiple times to obtain a result.

15. A computing system, comprising:
at least one processor connected to at least one memory;
a non-transitory computer readable medium including instructions stored thereon that when executed by at least the processor cause the processor to:
generate, via a graphical user interface (GUI), a visual guidance model of a multi-process scenario including creating one or more process goals, each of the one or more process goals defining a stage in a lifecycle of the multi-process scenario;
create, via the GUI, one or more objectives within each of the one or more process goals, each of the one or more objectives defining a task for accomplishing the corresponding process goal, and configuring at least one of the one or more objectives to display a description of the task performed by the objective;
configure, via the GUI, the one or more objectives to include one or more guided actions that partition the task to be performed into a sequence of guided actions for the corresponding objective;
for a selected objective from the one or more objectives, configuring, via the GUI, the one or more guided actions to display an explanation for how to perform the associated guided action upon being selected; and
wherein completion of the sequence of guided actions within an objective completes the corresponding objective, and completion of the one or more objectives within each process goal completes the corresponding process goal.

16. The computing system of claim 15, wherein the instructions further include instructions that when executed by at least the processor cause the processor to:
generate, via the GUI, a list of the one or more objectives for completing a corresponding process goal, wherein each described task for a corresponding objective describes a substage of the lifecycle for the corresponding process goal.

17. The computing system of claim 15, wherein the instructions further include instructions that when executed by at least the processor cause the processor to:
generate, via the GUI, a sequential diagram of the one or more guided actions within a corresponding objective, wherein the sequence diagram, completed in whole, performs the task described in the corresponding objective.

18. The computing system of claim 15, wherein the instructions further include instructions that when executed by at least the processor cause the processor to:
analyze, via the visual guidance model, a result produced by completing at least one of the one or more guided actions to determine how to route to a following guided action in the sequence.

19. The computing system of claim 15, wherein the instructions further include instructions that when executed by at least the processor cause the processor to: create, via the GUI, at least one of:
one or more content operations that populate the explanation for the displayed guided action, the displayed explanation guiding a user on performing the guided action and preparing for the next guided action within the sequence of guided actions, and
one or more autopilot operations that automatically populate content for automatically performing the guided action and complete one or more guided actions in the sequence of guided actions.

20. The computing system of claim 15, wherein the instructions further include instructions that when executed by at least the processor cause the processor to:
dynamically analyze, via the visual guidance model, a content and a configuration of the one or more guided actions to identify one or more actions for automatically completing the corresponding guided action, and wherein the visual guidance model displays the analyzed one or more guided actions as pending.
